(19) United States
(12) Patent Application Publication
(10) Pub. No.: US 2003/0014516 A1
(43) Pub. Date: Jan. 16, 2003

(54) Recovery support for reliable messaging

(75) Inventors: Robert S. Blackmore, Poughkeepsie, NY (US); Amy Xin Chen, Poughkeepsie, NY (US); Kevin J. Gildea, Bloomington, NY (US); Rama K. Govindaraju, Poughkeepsie, NY (US); Anand V. Hudli, Hopewell Junction, NY (US); Radha R. Kandadai, Lake Katrine, NY (US); Chulho Kim, Poughkeepsie, NY (US); Richard Rosenthal, Poughkeepsie, NY (US); Gautam H. Shah, Poughkeepsie, NY (US)

Correspondence Address: LAWRENCE D. CUTTER, Attorney, IBM Corporation, Intellectual Property Law Dept., 2455 South Rd., M/S P386, Poughkeepsie, NY, 12601, US

(73) Assignee: INTERNATIONAL BUSINESS MACHINES CORPORATION, ARMONK, NY (US)

(21) Appl. No.: 09/905,308

(22) Filed: Jul. 13, 2001

(51) Int. Cl. G06F 15/173

(52) U.S. Cl. 709/224; 709/238

(57) ABSTRACT

Interconnected data processing nodes can from time to time experience temporary failures or losses of communication links between system nodes. In systems which have a mechanism for determining whether the data processing nodes are operative or not, by providing an epoch number for use as an instance identifier and by providing a mechanism for controlling the generation and propagation of the epoch number, such systems are able to resume their respective tasks when failed nodes or communication links are restored.

### BACKGROUND OF THE INVENTION

The present invention is generally directed to methods and systems for providing reliable communication in a network of interconnected data processing nodes. More particularly, the present invention employs an identifier associated with the detection of a node failure to establish a time and status basis, both for terminating and for resuming communications. Even more particularly, the present invention provides a concise software mechanism and interface which permits this implementation within a set of interconnected nodes.

Typical message passing protocols assume that nodes or communication links do not fail. This is the case even when the protocols are reliable and deal with transient network failures, as distinguished from failures of the nodes or the communication links themselves. Thus, the behavior of typical message passing protocols is not well defined in the presence of node or communication link failures. Some communication protocols run in “user space,” and as typically implemented, are not “connection based,” but rather handle node failures by terminating the entire “job.” That is, in response to a node or communication link failure, the entire set of communicating processes is terminated. However, this is not a very desirable solution, especially if the set of communicating processes is in the kernel of the operating system, for instance, in a distributed I/O subsystem, since in such cases other processes could be affected. In such cases it is highly desirable to have workable mechanisms embedded in the communication protocols so as to properly handle node failures.

In addition to dealing with node or communication link failures, proposed solutions should offer the advantage of providing users with control over detection of node failure. In existing solutions to the problem of node or communication link failure, the lack of packet delivery is often assumed by the user to be caused by node or communication link failure thus eventually resulting in a connection time-out. There should therefore be a mechanism to provide the user with the ability to deal with the potentially large network delays engendered by connection time-outs so as to thus result in faster response times even in the face of node or communication link failure. Such mechanisms would therefore avoid the problem of waiting for the communication protocol to time-out.

When a failed node recovers it also should have the ability to renew communications with other the other nodes in the network. In order to do so, it must be “authenticated” so that message packets going to and/or from the node before node or communication link failure are distinguishable from packets going to and/or from the node after its failure. This is typically known to those skilled in the art as the “trickle traffic problem.”

### SUMMARY OF THE INVENTION

In accordance with a preferred embodiment of the present invention a method is provided for communicating reliably in an interconnected network of data processing nodes. When a node or communication link failure is detected, say by the use of a heartbeat detection mechanism, as provided in the p-Series of computers (formerly referred to as the RS/6000 SP machine) as manufactured and marketed by the assignee of the present invention, each node of the system associates a unique instance identifier or epoch number which is created and which is associated with the detected failure. Notification of this failure is sent to other nodes which have existing communication links with the failed node. At the nodes which are notified, pending communication links with the failed node are terminated based on the current epoch number and a new, unique epoch number is used for further communication. When the failed node comes back on line, communications are renewed with a new and unique epoch number providing an indication of the last valid packet transmission that occurred. Packets with incorrect (or old) epoch numbers are discarded by the receiver and this mechanism helps solve the classic trickle traffic problem. Two function calls are defined (See Appendix I) which facilitate the actions that take place at the individual nodes.

Accordingly, it is an object of the present invention to prevent the unnecessary transmission of data packets to a failed node in a network of interconnected data processing nodes.

It is also an object of the present invention to eliminate the trickle traffic problem.

It is yet another object of the present invention to prevent communication with failed data processing nodes.

It is a still further object of the present invention to avoid the termination of all jobs merely because of the failure of one of the nodes or communication links with or through which the job was communicating when failure occurred.

It is also an object of the present invention to permit failed nodes time to recover or reestablish failed communication links so that communication processes can be resumed where they left off.

It is yet another object of the present invention to take advantage of current capabilities for node or communication link failure detection to enhance internode communication functioning.

It is a still further object of the present invention to provide a simple, efficient and effective software interface mechanisms for preventing node or communication link failure from unnecessarily terminating job processes running on the system of nodes.

It is also an object of the present invention to improve internode communication processes involving messages to and from operating system kernels running on the various system nodes.

Lastly, but not limited hereto, it is an object of the present invention to provide an easy to use software interface for enhancing the communication function for efficient recovery from failures in the system.

The recitation herein of a list of desirable objects which are met by various embodiments of the present invention is not meant to imply or suggest that any or all of these objects are present as essential features, either individually or collectively, in the most general embodiment of the present invention or in any of its more specific embodiments.

### DESCRIPTION OF THE DRAWING

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is block diagram illustrating, in an interconnected system of nodes, epoch number transitions occurring as a result of node or communication link failure and how these events are handled using the present invention.

### DETAILED DESCRIPTION OF THE INVENTION

In preferred embodiments of the present invention interface software referred to as KLAPI (Kernel-based Low level Application Program Interface), as provided with the aforementioned p-Series of data processing systems, is extended to include two new functions which are usable in carrying out the method described herein. KLAPI is based on a kernel version of LAPI which is described in U.S. Pat. No. 6,038,604 and U.S. Pat. No. 6,070,189. LAPI is a user-space based, one sided reliable transport protocol available on the RS/6000 SP for over the SP switch. KLAPI or Kernel LAPI is a kernel based reliable transport protocol with zero copy extensions for kernel based subsystems.

In order to tolerate node or communication link failures, the communication subsystem provides interfaces to clean up the communication state (so that the protocol does not fail with a time-out). Furthermore, the protocol provides an infrastructure to detect messages that were sent before the node failure and to discriminate “against” those sent after the node or communication link failure. It is assumed that detection of the failure is available to the user through some mechanism. In the p-Series of products mentioned above, failure detection is provided by the heartbeat mechanism. In one version of a heartbeat mechanism each node periodically sends an “I am alive” signal to the next node in a circular chain of nodes. Each node is responsible for passing along this signal to a predetermined node. If an expected “I am alive” signal is not received within specified time limits, the node which detects this failure notifies all of the other nodes with which it is currently connected. It is clear that the failure of the “I am alive” signal can be attributed either to failure of a node or to the failure of a communication link attached to the node. However, it is possible, though not preferred, to employ topologies other than the circular topology just mentioned as a structural mechanism for determining which node is responsible for monitoring the “I am alive” signal for select nodes and for transmitting notification of such failure to selected other nodes.

The present invention provides two new interfaces in LAPI: (1) LAPI Purge_to_task through which a user can terminate all pending communication processes having a particular destination (when that destination has failed), and (2) LAPI_Resume_to_task through which a user can resume communication to a particular destination (after it has presumably come back up). In addition to these two interfaces the concept of Epoch number (or instance identifier as explained below) is introduced (that can be set by the user across different invocations of LAPI_Resume_to_task) so that messages that span different communication instances can be detected and appropriately ignored (i.e. trickle traffic).

The trickle traffic problem is well known in the field of communication protocols by those skilled in the art (both with respect to user-based and with respect to kernel-based protocols). Often the solution to this problem is that the communication is on a connection basis and when one of the nodes dies, the connection is dropped (which implies a cleaning up of the communication state). Furthermore, the dropping of connection automatically does not provide user control, faster response times, or the ability to avoid large delays in the network of nodes. There thus does not appear to be any solution to this problem that deals with node failures without also involving connection semantics.

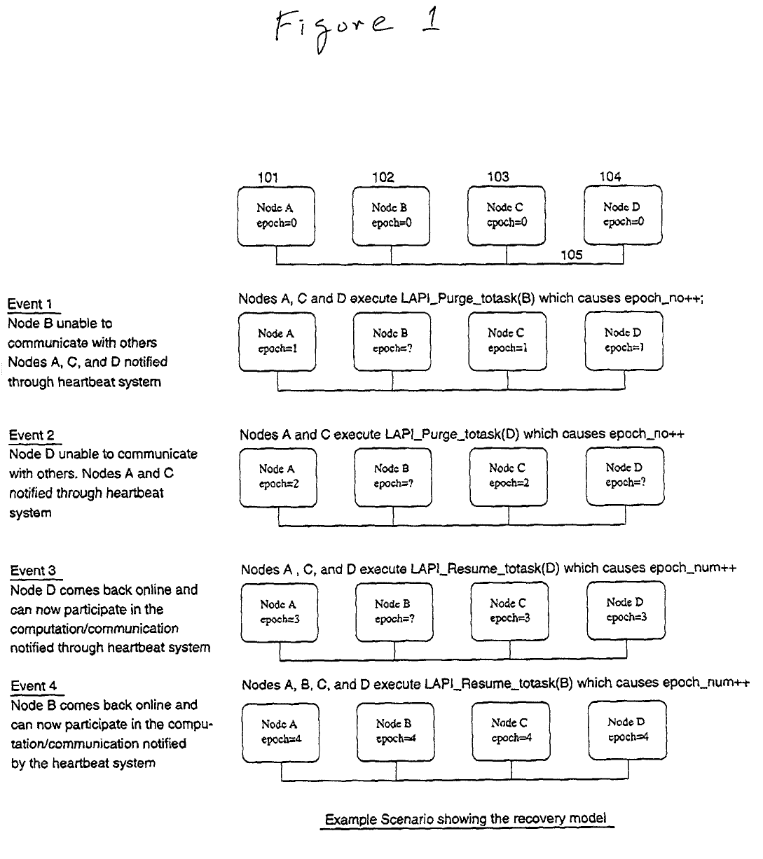

FIG. 1 illustrates an exemplary sequence of events which are useful for understanding the operation of the present invention. FIG. 1 illustrates a distributed multiprocessor system consisting of 4 nodes (labeled 101 for Node A, 102 for Node B, 103 for Node C, and 104 for Node D, and an interconnection network between these nodes labeled 105. The Nodes 101-104 use network 105 to communicate amongst themselves. In the beginning all 4 nodes communicate with each other using the epoch number 0. Note that the concepts specifically described in this example are not be limited to node-to-node communication but that they also apply to the communication between and/or among specific tasks or processes within each node. Such tasks or processes are often part of distributed applications.

The epoch number is packed into every packet that is injected into the network when communicating with other nodes in the system. A receiving node accepts a packet only if the epoch number in the packet matches with the epoch number it is expecting. Otherwise the packet is discarded as a trickle traffic packet. Hence in the beginning all nodes can communicate with every other node and the epoch numbers are consistent across all of the nodes.

During the course of execution of the parallel or distributed system Node B may lose connectivity to other nodes or may fail itself. This is reflected in FIG. 1 as Event 1. The other nodes in the application are eventually notified by the heartbeat system (Group Services) that Node B is not responding (due either to the failure of the node or the failure of connectivity to the node). This causes Nodes A, C, and D to execute the LAPI call LAPI_Purge_totask(B). This causes the state with respect to Node B to be reset by Node A, C, and D and also causes their epoch numbers to be bumped up to 1. This also causes all information or message packets from Node B sent to nodes A, C, or D with the epoch number 1 to be discarded by nodes A, C, and D as trickle traffic packets arriving from an instance of B that is no longer a participant in the parallel or distributed application. Nodes A, C and D continue communicating with each other using the new epoch number (which is now 1).

The next exemplary event shown in FIG. 1 as Event 2 is the that connectivity to node D is lost or that node D itself has failed. Again, as above, Nodes A and C are notified by Group Services (the heartbeat system) that node D is unreachable. This causes Nodes A and C to execute a LAPI_Purge_totask(D) causing their epoch numbers to be bumped up and future information (or message) packets from node D to be discarded. This is shown in FIG. 1 as Event 2.

The next event set out in the exemplary scenario shown in FIG. 1 is that node D now comes back online and would like to join the parallel or distributed application being run on nodes A and C. The heartbeat mechanism notifies nodes A and C that node D is now back online. Nodes A, C and D execute LAPI_Resume_totask(D) causing the epoch number to be bumped up and the state corresponding to D be set to be able to resume communication with node D and allowing D to join the parallel or distributed application. Now packets which are used to communicate between A, C and D use epoch number 3 and packets with older epoch numbers are discarded. This is shown in FIG. 1 as Event 3.

The next exemplary event shown in FIG. 1 is that node B now comes back online and would like to join the parallel or distributed application being run on nodes A, C, and D. The heartbeat mechanism notifies nodes A, B, C, and D that node B is now back online. Nodes A, B, C, and D execute the LAPI_Resume_totask(B) call which causes the epoch number to be bumped up and the state corresponding to node B be set to be able to resume communication with node B and allowing node B to join in communicating with the parallel or distributed application. Now packets used to communicate between nodes A, B, C, and D use epoch number 4 and packets with older epoch numbers are discarded. This is shown in FIG. 1 as Event 4.

Note that in this example it is evident that the epoch numbers have global scope and are the same on each node that is actively communicating while participating in the parallel or distributed application. Another possible implementation is to have the epoch number on a per source-and-destination basis but for reasons of simplicity the example here uses a common global epoch number to more readily appreciate the basic concepts. However, in its most general form the present invention is not so limited.

The present application refers to an indicator which is used to identify an instance of node or network failure as an “epoch number.” However, as used herein and in the appended claims, the term “instance identifier” is used as well. With respect to either phrase, the intent is to employ an indicia associated with a particular failure incident that has two characteristics: (1) unique association with that failure instance over a reasonable period of system operation; and (2) an ability to determine, as between two such specific indicia, which cam first in time.

The interaction of the various subsystems like Group services (for heartbeat function), the parallel or distributed application which is the user of LAPI, the use of the LAPI calls to purge and resume are the key aspects described in this invention. Aspects of LAPI, the parallel or distributed application using LAPI, group services, etc. and their key novelties have been filed for invention protection under previous patents from IBM (Larry please add appropriate references for them).

While the invention has been described in detail herein in accordance with certain preferred embodiments thereof, many modifications and changes therein may be effected by those skilled in the art. Accordingly, it is intended by the appended claims to cover all such modifications and changes as fall within the true spirit and scope of the invention.

[image]

[image]

[image]

The invention claimed is:

1. A method for providing reliable communication in an interconnected network of data processing nodes, said method comprising:
detecting a failure of nodes or communication links in a system using a heartbeat mechanism to indicate to said nodes that at least one of said nodes or said communication links are functioning or have failed;
establishing an instance identifier associated with said failure;
sending notification of said failure, including said instance identifier, to other nodes having existing communication links with said at least one failed node; and
terminating, at said notified nodes, pending communication links that involve said at least one failed node, said termination being carried out in response to said notification.

2. The method of claim 1 further including the step of detecting that said at least one failed node is no longer in a failed state and resuming communications with that node using an incremented value for said instance identifier.

3. The method of claim 2 further including the step of resuming communications with said other nodes using said incremented instance identifier.

4. A data processing system comprising:
a plurality of interconnected data processing nodes;
heartbeat signal generators within each said node for providing a signal to others of said nodes indicative of node failure status;
heartbeat signal detectors within said nodes for indicating that a certain node has failed;
a first program within said nodes for establishing an instance identifier associated with each node failure and for transmitting notification of said failure and said instance identifier to nonfailed nodes; and
a second program within said nodes for terminating, at said notified nodes, pending communication links that involve said at least one failed node, said termination being carried out in response to said notification.

5. The data processing system of claim 4 in which said heartbeat signal detectors also provide an indication that a failed node has returned to functioning status.

6. The data processing system of claim 5 further comprising a third program within said nodes which resumes communication with nodes that have returned to functioning status, said communication including transmission of a new instance identifier.

7. A computer program product comprising a computer readable medium on which is stored program means for:
detecting a failure of nodes or communication links in a system using a heartbeat mechanism to indicate to said nodes that at least one of said nodes or said communication links are functioning or have failed;
establishing an instance identifier associated with said failure;
sending notification of said failure, including said instance identifier, to other nodes having existing communication links with said at least one failed node; and
terminating, at said notified nodes, pending communication links that involve said at least one failed node, said termination being carried out in response to said notification.
